(19) United States
(12) Patent Application Publication
(10) Pub. No.: US 2024/0227605 A9
(43) Pub. Date: Jul. 11, 2024

(54) MANAGEMENT APPARATUS

(71) Applicant: TOYOTA JIDOSHA KABUSHIKI KAISHA, Toyota-shi Aichi-ken (JP)

(72) Inventors: Motofumi KAMIYA, Nagoya-shi Aichi-ken (JP); Hiroki Takeishi, Machida-shi Tokyo-to (JP)

(73) Assignee: TOYOTA JIDOSHA KABUSHIKI KAISHA, Toyota-shi Aichi-ken (JP)

(21) Appl. No.: 18/381,708

(22) Filed: Oct. 19, 2023

(30) Foreign Application Priority Data
Oct. 21, 2022 (JP) 2022-169487

(51) Int. Cl. B60L 53/60; B60L 53/53; B60L 58/12; B60Q 9/00

(52) U.S. Cl. CPC B60L 53/60; B60L 53/53; B60L 58/12; B60Q 9/00

(57) ABSTRACT

A management apparatus includes a controller configured to manage a power supply vehicle. The controller is configured to notify a user of a result of a determination of whether the power supply vehicle can supply power to a vehicle of the user under specified conditions that include a position specified by the user and a time specified by the user. The controller is configured to accept a reservation for the power supply vehicle to supply power to the vehicle of the user.

### CROSS-REFERENCE TO RELATED APPLICATION

This application claims priority to Japanese Patent Application No. 2022-169487, filed on Oct. 21, 2022, the entire contents of which are incorporated herein by reference.

### TECHNICAL FIELD

The present disclosure relates to a management apparatus for power supply vehicles.

### BACKGROUND

A power supply apparatus that can supply power, stored in a power supply battery unit of a power supply vehicle, to a power supply receiving battery unit of a power supply receiving vehicle is known. For example, see Patent Literature (PTL) 1.

### CITATION LIST

### Patent Literature

PTL 1: JP 2022-078393 A

### SUMMARY

Demand exists for improvement in the convenience for users of power supply services.

It would be helpful to improve the convenience for users of power supply services.

A management apparatus according to an embodiment of the present disclosure includes a controller configured to manage a power supply vehicle. The controller is configured to notify a user of a result of a determination of whether the power supply vehicle can supply power to a vehicle of the user under specified conditions that include a position specified by the user and a time specified by the user. The controller is configured to accept a reservation for the power supply vehicle to supply power to the vehicle of the user.

According to a management apparatus in an embodiment of the present disclosure, the convenience for users of power supply services can be enhanced.

### BRIEF DESCRIPTION OF THE DRAWINGS

In the accompanying drawings:

FIG. 1 is a block diagram illustrating an example configuration of a management system according to an embodiment;

FIG. 2 is a diagram illustrating an example display of a power suppliable range and a power non-suppliable point;

FIG. 3 is a flowchart illustrating an example procedure of a management method according to an embodiment;

FIG. 4 is a flowchart illustrating example procedures for a management apparatus to accept a reservation;

FIG. 5 is a flowchart illustrating example procedures for accepting a reservation at a specified time; and

FIG. 6 is a flowchart illustrating example procedures for accepting a reservation at a specified position.

### DETAILED DESCRIPTION

(Example Configuration of Management System 1)

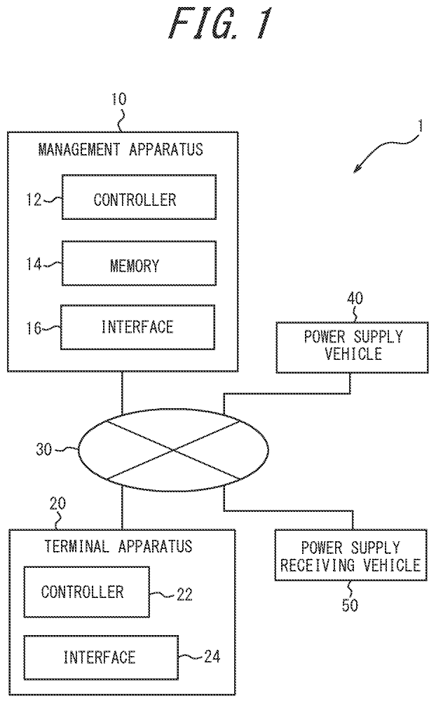

As illustrated in FIG. 1, a management system 1 according to an embodiment includes a management apparatus 10, a terminal apparatus 20, a power supply vehicle 40, and a power supply receiving vehicle 50. The management system 1 provides a power supply service that supplies power from the power supply vehicle 40 to a battery of the power supply receiving vehicle 50. The management apparatus 10 accepts a reservation, from a user who owns or manages the power supply receiving vehicle 50, for power supply work by the power supply vehicle 40 to the battery of the power supply receiving vehicle 50. The management apparatus 10 manages the operation of the power supply vehicle 40 so that the power supply vehicle 40 travels to the position specified in the reservation at the time specified in the reservation. An example configuration of the management system 1 will be described below.

<Management Apparatus 10>

The management apparatus 10 includes a controller 12, a memory 14, and an interface 16.

The controller 12 controls at least one component of the management apparatus 10. The controller 12 may be configured to include at least one processor. The “processor” is a general purpose processor, a dedicated processor specialized for specific processing, or the like in the present embodiment but not limited to these. The controller 12 may be configured to include at least one dedicated circuit. The dedicated circuit may include, for example, a field-programmable gate array (FPGA) or an application specific integrated circuit (ASIC). The controller 12 may be configured with the dedicated circuit instead of the processor, or may be configured with the dedicated circuit along with the processor.

The memory 14 is configured to include a semiconductor memory, a magnetic memory, an optical memory, or the like, for example, but is not limited to these. The memory 14 may function as, for example, a main memory, an auxiliary memory, or a cache memory. The memory 14 may be configured to include an electromagnetic storage medium, such as a magnetic disk. The memory 14 may be configured to include a non-transitory computer readable medium. The memory 14 stores any information or program to be used for operations of the management apparatus 10. The memory 14 may, for example, store a system program, an application program, or the like. The memory 14 may be included in the controller 12.

Information, data, or the like is outputted from and inputted to the controller 12 through the interface 16. The interface 16 may include a communication module for communication to other apparatuses, such as the terminal apparatuses 20, via a network 30. The communication module may be, for example, compliant with a mobile communication standard, such as the 4th Generation (4G) standard or the 5th Generation (5G) standard. The communication module may be compliant with a communication standard, such as a Local Area Network (LAN). The communication module may be compliant with a wired or wireless communication standard. The communication module is not limited to these examples and may be compliant with various communication standards. The interface 16 may be configured to be capable of connecting to a communication module.

The interface 16 may be configured with an input device for accepting input of information, data, or the like from the user. The input device may be configured with, for example, a touch panel, a touch sensor, or a pointing device such as a mouse. The input device may be configured with a physical key. The input device may be configured with an audio input device, such as a microphone. The interface 16 may be configured to be capable of connecting to an external input device. The interface 16 may be configured to be capable of acquiring, from an external input device, information or data inputted to the external input device.

The interface 16 may be configured to include an output device that outputs information, data, or the like to the user. The output device may include, for example, a display device that outputs visual information, such as images, letters, or graphics. The display device may be configured with, for example, a Liquid Crystal Display (LCD), an organic or inorganic Electro-Luminescent (EL) display, a Plasma Display Panel (PDP), or the like. The display device is not limited to the above displays and may be configured with various other types of displays. The display device may be configured with a light emitting device, such as a Light Emitting Diode (LED) or a Laser Diode (LD). The display device may be configured with various other devices. The output device may include, for example, an audio output device, such as a speaker, that outputs audio information, such as voice. The output device is not limited to the above examples and may include various other devices. The interface 16 may be configured to be capable of connecting to an external output device. The interface 16 may be configured to be capable of outputting information or data to an external output device.

The management apparatus 10 may be configured to include a single server apparatus or a plurality of server apparatuses capable of communicating with each other. The management apparatus 10 may be implemented as a cloud server.

<Terminal Apparatus 20>

The terminal apparatus 20 is communicably connected to the management apparatus 10 and the like via the network 30. The terminal apparatus 20 includes a controller 22 and an interface 24.

The controller 22 may be configured with one or more processors or one or more dedicated circuits. The controller 22 may be configured to be identical or similar to the controller 12 of the management apparatus 10. The controller 22 may be configured to include a memory. The memory may be configured to be identical or similar to the memory 14 of the management apparatus 10.

The interface 24 may include input devices, output devices, or communication devices. The interface 24 may be configured to be identical or similar to the interface 16 of the management apparatus 10. The interface 24 may be communicably connected in a wired or wireless manner to the management apparatus 10 and the like. The interface 24 may include a display device. The terminal apparatus 20 may function as a display apparatus in the case of including a display device as the interface 24.

The terminal apparatus 20 may be carried by the user or may be installed at a predetermined location. The terminal apparatus 20 may be configured as a mobile terminal, such as a smartphone or a tablet, or a Personal Computer (PC), such as a notebook PC or a tablet PC. The terminal apparatuses are not limited to the above examples and may include various devices. The number of terminal apparatuses 20 included in the management system 1 is not limited to one and may be two or more.

<Power Supply Vehicle 40 and Power Supply Receiving Vehicle 50>

The power supply receiving vehicle 50 may be an electric vehicle that is driven using battery power. Electric vehicles may include a Hybrid Electric Vehicle (HEV), a Plug-in Hybrid Electric Vehicle (PHEV), a Fuel Cell Electric Vehicle (FCEV), or a Battery Electric Vehicle (BEV). The power supply receiving vehicle 50 is also referred to simply as the vehicle. The number of power supply receiving vehicles 50 using the power supply service provided by the management system 1 is not limited to one and may be two or more.

The power supply vehicle 40 may be a vehicle with an engine or an electric vehicle. The number of power supply vehicles 40 managed by the management system 1 is not limited to one and may be two or more.

The power supply vehicle 40 may be equipped with a power supply apparatus for supplying power to the power supply receiving vehicle 50. The power supply apparatus may include at least one battery. The power supply apparatus may include a converter, inverter, or the like that controls the current or voltage supplied from the battery to the power supply receiving vehicle 50.

The power supply vehicle 40 may be configured to supply power to the power supply receiving vehicle 50 from a battery of the power supply vehicle 40 itself. The power supply vehicle 40 may include a power supply cable or power supply connector for connecting to the power supply receiving vehicle 50. The power supply vehicle 40 may include a device configured to provide a contactless power supply to the power supply receiving vehicle 50. The operation to supply power from the power supply vehicle 40 to the power supply receiving vehicle 50 may be performed by a worker of the power supply vehicle 40 or by the user of the power supply receiving vehicle 50. The power supply vehicle 40 may be configured to supply power automatically to the power supply receiving vehicle 50.

The power supply vehicle 40 or the power supply receiving vehicle 50 may include a communication device that is communicably connected to the management apparatus 10, the terminal apparatus 20, or the like.

The power supply vehicle 40 or the power supply receiving vehicle 50 may further include a positional information detection apparatus that acquires positional information. The positional information detection apparatus may output positional information for the power supply vehicle 40 or the power supply receiving vehicle 50 to the management apparatus 10. The positional information detection apparatus may be configured to include a receiver compliant with a satellite positioning system. The receiver compliant with the satellite positioning system may be configured to include, for example, a Global Positioning System (GPS) receiver.

The power supply vehicle 40 or the power supply receiving vehicle 50 may be configured to be operated by a driver or configured to travel autonomously.

(Operation Example of Management System 1)

In the management system 1 according to the present embodiment, the terminal apparatus 20 accepts input, from the user, specifying the user's desired conditions, including the desired time and desired position for power supply to the power supply receiving vehicle 50, and outputs the input to the management apparatus 10. In a case in which the power supply vehicle 40 can supply power under the user's desired conditions, the management apparatus accepts a reservation to perform a power supply operation on the user's power supply receiving vehicle 50 at the user's desired time and desired position. The management apparatus 10 manages the operation of the power supply receiving vehicle 50 for the power supply vehicle 40 to arrive at the user's desired position by the user's desired time. Hereinafter, specific example operations of the management apparatus 10 will be described. In the following description, the number of power supply vehicles 40 managed by the management system 1 is assumed to be two or more.

<Setting and Notification of Position at which Power can be Supplied>

The controller 12 of the management apparatus 10 sets the positions or range over which the power supply operation can be performed for the power supply receiving vehicle 50. The position at which the power supply operation can be performed on the power supply receiving vehicle 50 is also referred to as the position at which power can be supplied. The position at which power can be supplied corresponds to a position to which the power supply vehicle can move. The range over which the power supply operation can be performed on the power supply receiving vehicle 50 is also referred to as the range over which power can be supplied. The range over which power can be supplied corresponds to the range over which the power supply vehicle 40 can move. The range over which power can be supplied may be expressed as a set of positions at which power can be supplied.

The position at which power can be supplied or the range over which power can be supplied can vary depending on the time when the power supply operation for the power supply receiving vehicle 50 starts. The position at which power can be supplied or the range over which power can be supplied is determined based on the position of the power supply vehicle 40 prior to the start of the power supply operation. The longer the time until the start of the power supply operation, the wider the range over which power can be supplied. For example, the position at which power can be supplied or the range over which power can be supplied in a case in which the power supply operation starts at time T1 is determined based on the position of the power supply vehicle 40 at time T1−ΔT1 and the range over which the power supply vehicle can travel during time ΔT1. The range over which the power supply vehicle can travel during time ΔT1 is determined by factors such as the travel capability of the power supply vehicle 40 or the traffic conditions on the travel route. In a case in which the power supply vehicle 40 is performing a power supply operation during the period prior to time T1, the power supply vehicle cannot move until the power supply operation is completed. Therefore, the position at which power can be supplied or the range over which power can be supplied in the case in which the power supply operation starts at time T1 is determined based on the position at which a power supply operation is being performed before time T1 and the end time of that power supply operation.

The power supply vehicle 40 performs the power supply operation over a finite period of time. The position at which power can be supplied or the range over which power can be supplied can vary depending on the time when the power supply operation for the power supply receiving vehicle 50 ends. In a case in which a power supply operation to be performed by the power supply vehicle 40 has already been reserved, the power supply vehicle 40 needs to be in position for performing the next reserved power supply operation at the start time of that power supply operation. Therefore, the position at which power can be supplied or the range over which power can be supplied is determined based on the position for performing the next reserved power supply operation. The longer the time between the end of the power supply operation for a power supply receiving vehicle 50 and the start of the next reserved power supply operation, the wider the range over which power can be supplied. For example, the position at which power can be supplied or the range over which power can be supplied in a case in which the power supply operation ends at time T2 is determined based on the range over which the power supply vehicle 40 can travel during a time ΔT2 until the start time of the next reserved power supply operation.

In a case of performing a power supply operation for the power supply receiving vehicle 50 during the period from time T1 to time T2, the controller 12 may generate the position at which power can be supplied or the range over which power can be supplied for each power supply vehicle 40 in a plurality of power supply vehicles 40 managed by the management system 1. The controller 12 may generate the position at which power can be supplied or the range over which power can be supplied for at least a portion of the power supply vehicles 40. The controller 12 may generate the position at which power can be supplied or range over which power can be supplied for a power supply receiving vehicle 50 by combining the generated positions at which power can be supplied or ranges over which power can be supplied for each power supply vehicle 40.

The position at which power can be supplied or the range over which power can be supplied is limited to the position or range into which the power supply vehicle 40 can enter. The position at which power can be supplied is limited to the position at which the power supply vehicle 40 can perform a power supply operation for the power supply receiving vehicle 50. Conversely, the power supply vehicle 40 may not be able to perform the power supply operation to the power supply receiving vehicle 50 even at a position within the range over which power can be supplied. A position at which the power supply vehicle 40 cannot perform a power supply operation for the power supply receiving vehicle 50 is referred to as a position at which power cannot be supplied. The position at which power cannot be supplied is a position at which the power supply vehicle 40 can enter but cannot perform a power supply operation. For example, a parking space in a multi-level parking garage or a parking space with a narrow surrounding space may fall under the category of positions at which power cannot be supplied.

The controller 12 may notify the user of the generated position at which power can be supplied or range over which power can be supplied. The controller 12 may notify the user of the position at which power can be supplied or range over which power can be supplied by displaying the position at which power can be supplied or range over which power can be supplied on a display device of the interface 16. The controller 12 may output the position at which power can be supplied or range over which power can be supplied to the terminal apparatus 20. The terminal apparatus 20 may notify the user of the position at which power can be supplied or range over which power can be supplied by displaying the position at which power can be supplied or range over which power can be supplied on a display device (display apparatus) of the interface 24.

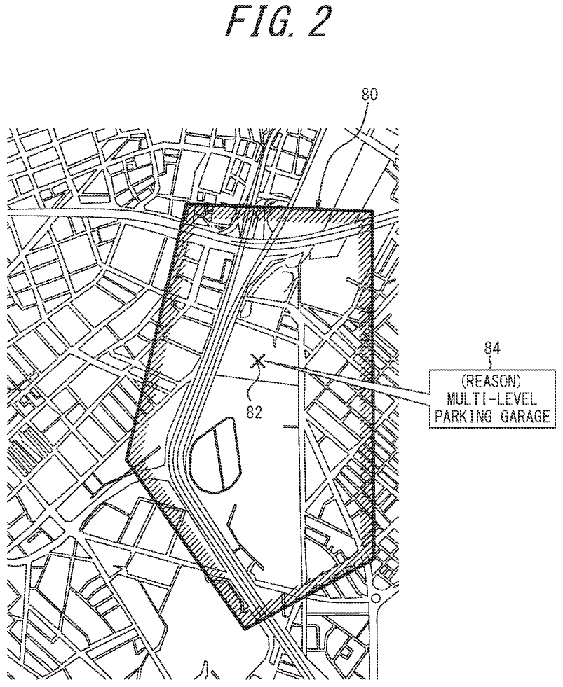

As illustrated in FIG. 2, the controller 12 may display an area 80, corresponding to the range over which power can be supplied, on a map. In this way, the user can easily understand the area 80 that corresponds to the range over which power can be supplied. The controller 12 may also display a mark 82, corresponding to a position at which power cannot be supplied within the area 80 corresponding to the range over which power can be supplied, on the map. In FIG. 2, the mark 82 corresponding to the position at which power cannot be supplied is indicated by an X. The controller 12 may also indicate the reason why a power supply operation cannot be performed at the position at which power cannot be supplied as a comment frame 84. In the comment frame 84 in FIG. 2, the fact that the position is a multi-level parking garage is indicated as the reason why the power supply operation cannot be performed. In this way, the user can easily understand the existence of a position at which power cannot be supplied and the reason why power cannot be supplied.

<Determination of Availability of Power Supply Under Specified Conditions and Acceptance of Reservation>

The controller 12 acquires conditions that the user specifies when reserving a power supply operation for the power supply receiving vehicle 50. The conditions specified by the user are also referred to as specified conditions. The controller 12 may accept input of specified conditions by the user on an input device of the interface 16. The controller 12 may acquire specified conditions inputted to the terminal apparatus 20. The terminal apparatus 20 may accept input of specified conditions by the user on an input device of the interface 24 and may output the inputted specified conditions to the management apparatus 10.

The controller 12 may acquire the position or range for performing the power supply operation as specified by the user as a specified condition. The controller 12 may acquire a time or a time slot for starting the power supply operation as specified by the user as a specified condition. The controller 12 may acquire a time or a time slot for ending the power supply operation as specified by the user as a specified condition. The controller 12 may estimate the time required to fully charge the battery based on the state of charge (SOC) of the battery in the power supply receiving vehicle 50 of the user and may calculate the time or time slot for ending the power supply operation according to the time or time slot for starting the power supply operation.

When accepting input of specified conditions from the user, the controller 12 may present the user with positions at which power can be supplied or a range over which power can be supplied, set in advance, and have the user select a specified position or specified range to perform the power supply operation from among the positions at which power can be supplied or the range over which power can be supplied. When accepting input of specified conditions from the user, the controller 12 may present the user with time slots during which power can be supplied, set in advance, and have the user select a specified time or a specified time slot to start the power supply operation from within the time slots during which power can be supplied. The controller 12 may present the user with conditions under which power can be supplied, set in advance, and have the user select a specified position or specified range to perform the power supply operation, and a specified time or a specified time slot to start the power supply operation, from among the conditions under which power can be supplied.

The controller 12 may extract power supply vehicles 40 that can perform the power supply operation under the specified conditions. The controller 12 may extract the power supply vehicles 40 that can move to the specified position by the time specified as the start time of the power supply operation by the power supply vehicle 40. The controller 12 may further extract the power supply vehicles 40 that can travel after the completion of the power supply operation to arrive in time for the next reserved power supply operation. In other words, the controller 12 may extract power supply vehicles 40 that can travel to the specified position by the specified time to perform a power supply operation and can then travel to the position to perform the next reserved power supply operation. The controller 12 determines that power can be supplied under the specified conditions in a case in which there are one or more power supply vehicles 40 that satisfy the conditions. The controller 12 determines that power cannot be supplied under the specified conditions in a case in which there is no power supply vehicle 40 that satisfies the conditions.

In a case in which it is determined that power can be supplied under the specified conditions, the controller 12 may accept a reservation for a power supply operation under the specified conditions and assign one of the extracted power supply vehicles 40 to the power supply operation. The controller 12 may notify the user via the terminal apparatus 20 that the reservation for the power supply operation has been accepted. The controller 12 may notify the user via the interface 16 that the reservation for the power supply operation has been accepted.

In a case in which the controller 12 determines that power cannot be supplied under the specified conditions, the terminal apparatus 20 or the interface 16 may notify the user to change the specified conditions. The controller 12 may calculate and notify the user of a time, as an alternative condition, at which the power supply operation can start at the specified position. The controller 12 may calculate and notify the user of a position, as an alternative condition, at which the power supply operation can start at the specified time. The controller 12 may generate and notify the user of alternative conditions for the power supply operation to start at a different time than the specified start time and at a different position than the specified position. The controller 12 may generate alternative conditions so that the distance between the specified position and the position to be notified as an alternative condition and the difference between the specified start time and the start time to be notified as an alternative condition are each smaller. The controller 12 may calculate an evaluation value by multiplying the position in the alternative condition and the start time in the alternative condition each by a weighting factor and may generate the alternative conditions so that the evaluation value is minimized.

The controller 12 may notify the user via the interface 16, or via the interface 24 of the terminal apparatus 20, of the result of the determination of whether the power supply operation is possible under the specified conditions. The controller 12 may accept input of a reservation from the user via the interface 16, or via the interface 24 of the terminal apparatus 20, after the user has confirmed the determination result.

The controller 12 may update the conditions under which power can be supplied for the case of another user reserving a power supply operation based on the results of the determination of whether the power supply operation is possible under the specified conditions, the results of generating alternative conditions, or the conditions of the power supply operation reserved by the user.

<Operation of Power Supply Vehicle 40>

The controller 12 may generate an operation schedule for the power supply vehicle 40 to perform the reserved power supply operation. The controller 12 may output the operation schedule to the power supply vehicle and manage the operation of the power supply vehicle 40. In a case in which the power supply vehicle 40 is operated by a driver, the controller 12 may notify the driver of the operation schedule. In a case in which the power supply vehicle 40 drives autonomously, the controller 12 may output the operation schedule or control information to a control apparatus for autonomous driving of the power supply vehicle 40.

<Example Procedure for Management Method>

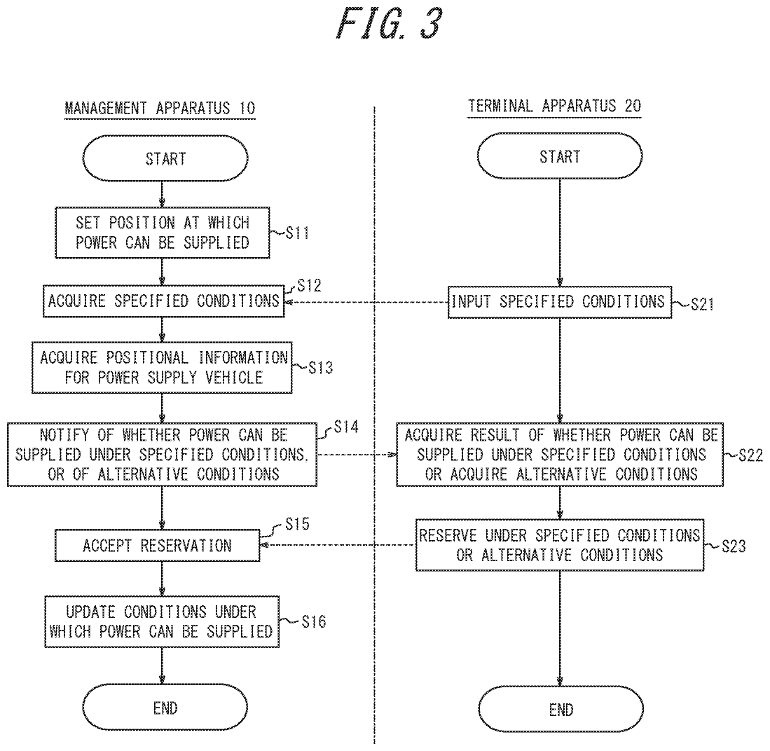

To provide a power supply service, the management system 1 according to the present embodiment may perform a management method that includes the procedures of the flowchart illustrated in FIG. 3. The management method may be implemented as a management program to be executed by the controller 12 of the management apparatus 10 and the controller 22 of the terminal apparatus 20. The management program may be stored on a non-transitory computer readable medium.

The controller 12 of the management apparatus 10 sets the position at which power can be supplied (step S11).

The controller 22 of the terminal apparatus 20 accepts input of specified conditions from the user via the interface 24 (step S21). The controller 22 outputs the specified conditions to the management apparatus 10.

The controller 12 of the management apparatus 10 acquires the conditions specified by the user (step S12). The controller 12 acquires positional information for the power supply vehicle 40 (step S13). The controller 12 determines whether power can be supplied under the specified conditions based on the positional information for the power supply vehicle 40 or the reservation status of the power supply vehicle 40. The controller 12 generates alternative conditions in a case in which power cannot be supplied under the specified conditions. The controller 12 notifies the user, by output to the terminal apparatus 20, of the result of determination of whether power can be supplied under the specified conditions, or of the generated alternative conditions (step S14).

The controller 22 of the terminal apparatus 20 acquires the result of determination of whether power can be supplied under the specified conditions or acquires the alternative conditions (step S22). The controller 22 accepts reservation input for a power supply operation under the specified conditions or the alternative conditions via the interface 24 (step S23). The controller 22 outputs the reservation input for the power supply operation to the management apparatus 10. After executing the procedure in step S23, the controller 22 can end the execution of the procedures in the flowchart of FIG. 3.

The controller 12 of the management apparatus 10 acquires the reservation input from the terminal apparatus 20 and accepts the reservation (step S15). The controller 12 notifies the user, by output to the terminal apparatus 20, that the reservation has been accepted. The controller 12 updates the conditions under which power can be supplied (step S16). After executing the procedure in step S16, the controller 12 can end the execution of the procedures in the flowchart of FIG. 3.

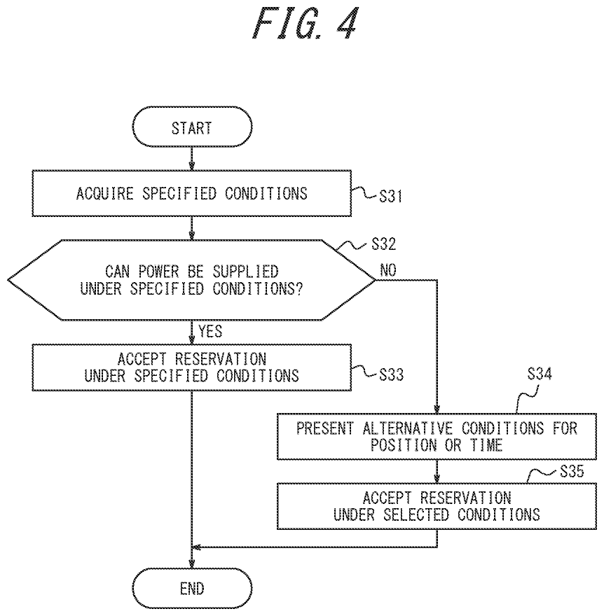

The controller 12 of the management apparatus 10 according to the present embodiment may perform a management method including the procedures of the flowchart in FIG. 4, for example, to accept a reservation for a power supply operation from the user.

The controller 12 acquires the specified conditions (step S31). The controller 12 determines whether a power supply operation can be performed under the specified conditions (step S32). In a case in which the power supply operation can be performed under the specified conditions (step S32: YES), the controller 12 accepts the reservation under the specified conditions (step S33). After executing step S33, the controller 12 can end the execution of the procedures in FIG. 4.

In a case in which the power supply operation cannot be performed under the specified conditions (step S32: NO), the controller 12 generates alternative conditions for the position or time to perform the power supply operation and presents the alternative conditions to the user (step S34). The controller 12 accepts a reservation under the conditions selected by the user from among the alternative conditions (step S35). After executing step S35, the controller 12 can end the execution of the procedures in FIG. 4.

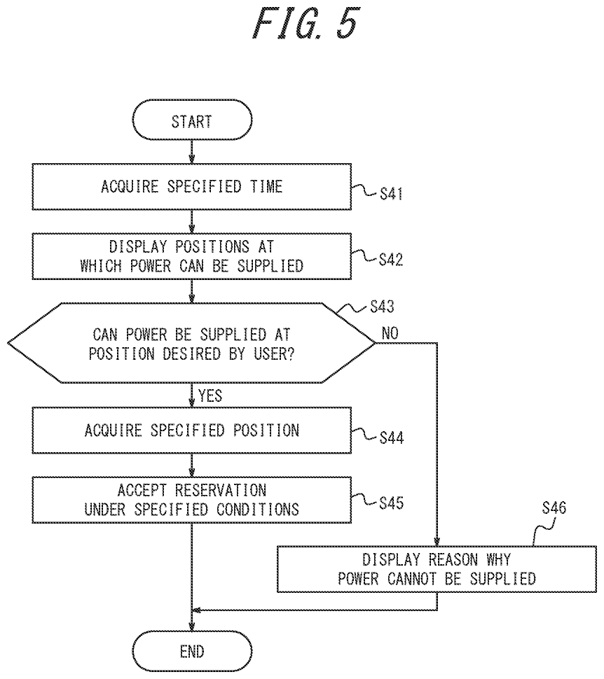

The controller 12 of the management apparatus 10 according to the present embodiment may perform a management method including the procedures of the flowchart in FIG. 5, for example, to display a position at which a power supply operation can be performed at the time specified by the user and accept a reservation for a power supply operation from the user.

The controller 12 acquires the specified time (step S41). The controller 12 calculates the position at which the power supply operation can be performed at the specified time and displays the position at which power can be supplied on the display apparatus (step S42). The controller 12 determines whether a power supply operation can be performed at the position desired by the user (step S43). In a case in which the power supply operation can be performed at the position desired by the user (step S43: YES), the controller 12 acquires the position desired by the user as the specified position (step S44). The controller 12 accepts a reservation under the specified conditions, including the specified time and specified position (step S45). After executing step S45, the controller 12 can end the execution of the procedures in FIG. 5.

In a case in which the power supply operation cannot be performed at the position desired by the user (step S43: NO), the controller 12 displays, on the display apparatus, the reason why power cannot be supplied at the position desired by the user (step S46). After executing step S46, the controller 12 can end the execution of the procedures in FIG. 5. The controller 12 may present alternative conditions or reacquire the specified time.

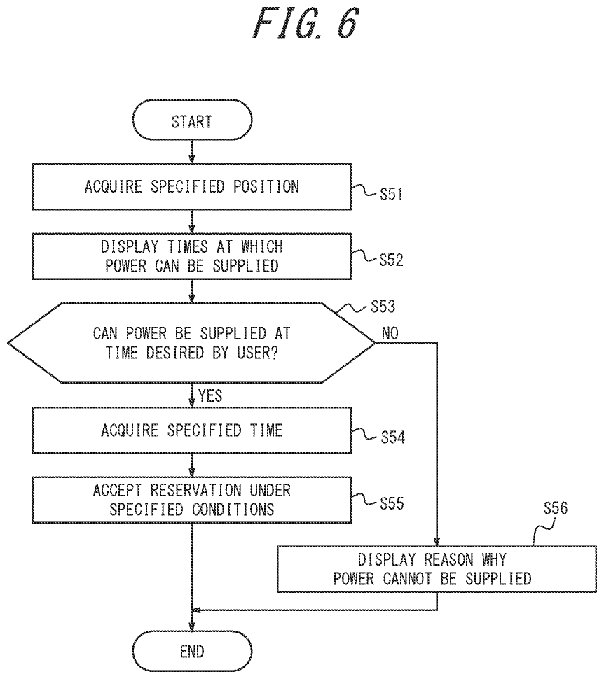

The controller 12 of the management apparatus 10 according to the present embodiment may perform a management method including the procedures of the flowchart in FIG. 6, for example, to display a time at which a power supply operation can be performed at the position specified by the user and accept a reservation for a power supply operation from the user.

The controller 12 acquires the specified position (step S51). The controller 12 calculates the times at which the power supply operation can be performed at the specified position and displays the times at which power can be supplied on the display apparatus (step S52). The controller 12 determines whether a power supply operation can be performed at the time desired by the user (step S53). In a case in which the power supply operation can be performed at the time desired by the user (step S53: YES), the controller 12 acquires the time desired by the user as the specified time (step S54). The controller 12 accepts a reservation under the specified conditions, including the specified position and specified time (step S55). After executing step S55, the controller 12 can end the execution of the procedures in FIG. 6.

In a case in which the power supply operation cannot be performed at the time desired by the user (step S53: NO), the controller 12 displays, on the display apparatus, the reason why power cannot be supplied at the time desired by the user (step S56). After executing step S56, the controller 12 can end the execution of the procedures in FIG. 6. The controller 12 may present alternative conditions under which power can be supplied or reacquire the specified position.

As illustrated in the example procedures of the flowcharts in FIGS. 5 and 6, the controller 12 may notify the user of at least one of the time at which power can be supplied at the position specified by the user or the position at which power can be supplied at the time specified by the user. In this way, it is easier for the user to specify the conditions for the power supply operation. User convenience is thereby improved.

### SUMMARY

As described above, in the management system 1 according to the present embodiment, the management apparatus 10 determines whether a power supply operation for the power supply receiving vehicle 50 can be performed under the conditions specified by the user, notifies the user of the determination result, and accepts a reservation for the power supply operation from the user. In this way, the user can receive a supply of power in a planned manner. In addition, reservations for power supply operations at positions where power supply operations cannot be performed can be avoided. User convenience is thereby improved.

The management apparatus 10 may notify the user of the position at which power can be supplied or the range over which power can be supplied by way of display on a map in the display apparatus, as illustrated in FIG. 2. In this way, it is easier for the user to specify the position at which the power supply operation is to be performed. User convenience is thereby improved.

### Other Embodiments

An example configuration of a management system 1 according to another embodiment will be described below.

<Consideration of Range of Movement of Power Supply Receiving Vehicle 50>

The power supply receiving vehicle 50 can move to a position for receiving the power supply operation. The controller 12 may calculate the position at which power can be supplied or the range over which power can be supplied by considering the range over which the power supply receiving vehicle 50 can move.

The controller 12 may acquire the positional information for the power supply receiving vehicle 50. The controller 12 may determine the time at which the power supply operation can be performed at the position specified by the user within a range of times by which the power supply receiving vehicle 50 can arrive at the specified position. The controller 12 may determine the position at which the power supply operation can be performed at the time specified by the user within a range of positions at which the power supply receiving vehicle 50 can arrive by the specified time. In this way, reservations for power supply operations at positions where power supply operations cannot be performed can be avoided.

In a case in which there is no time at which the power supply operation can be performed at the position specified by the user, or in a case in which there is no position at which the power supply operation can be performed at the time specified by the user, the controller 12 may notify the user of information identifying the reason why the power supply operation cannot be performed under those conditions. In this way, the user can understand why power cannot be supplied and change the specified conditions appropriately. User convenience is thereby improved.

<Recommended Power Supply Range>

The controller 12 may acquire the state of charge of the battery in the power supply receiving vehicle 50. In a case in which the state of charge of the battery in the power supply receiving vehicle 50 is less than a charge threshold, the controller 12 may notify the user of information recommending to charge the power supply receiving vehicle 50. Based on the positional information for the power supply receiving vehicle 50 and the state of charge of the battery in the power supply receiving vehicle 50, the controller 12 may calculate a range within which the power supply receiving vehicle 50 will be located while the state of charge of the battery in the power supply receiving vehicle 50 is below the charge threshold. The controller 12 may calculate a range that includes a route traveled by the power supply receiving vehicle 50 while the state of charge is below the charge threshold as the range within which the power supply receiving vehicle 50 will be located while the state of charge of the battery in the power supply receiving vehicle 50 is below the charge threshold. The controller 12 may recommend, and present to the user, that a power supply vehicle 40 be dispatched for performing a power supply operation to the range within which the power supply receiving vehicle 50 will be located while the state of charge of the battery in the power supply receiving vehicle 50 is below the charge threshold. The range in which performance of a power supply operation is recommended is also referred to as the recommended power supply range.

The controller 12 may calculate the times at which the power supply operation can be performed in the recommended power supply range. The controller 12 may notify the user of the recommended power supply range and the times at which power can be supplied within the recommended power supply range. The controller 12 may accept via the interface 16, or via the interface 24 of the terminal apparatus 20, a position specified by the user from the recommended power supply range and a time specified by the user from among the times at which power can be supplied in the recommended power supply range. In this way, a situation in which the power supply receiving vehicle 50 cannot run due to a low state of charge of the battery can be avoided. User convenience is thereby improved.

<Database of Conditions under which Power can be Supplied>

The controller 12 may generate a database that stores information identifying positions or times at which the power supply vehicle 40 was able to perform the power supply operation. The controller 12 may generate a database that stores information identifying positions or times at which the power supply vehicle 40 was not able to perform the power supply operation. The controller 12 may generate a database that stores both the conditions under which the power supply operation could be performed and the conditions under which the power supply operation could not be performed.

The controller 12 may determine, based on the database, the positions or times at which the power supply vehicle 40 can perform a power supply operation on the power supply receiving vehicle 50. In this way, the conditions under which power can be supplied can be easily determined. As a result, the processing load can be reduced.

<Display when Specifying Position of the Power Supply Operation>

The controller 12 may display one continuous map that includes the position of the terminal apparatus 20 of the user and the position at which the user desires the power supply operation and may accept input of the specified position on the map. In a case in which the distance between the position of the terminal apparatus 20 of the user and the position at which the user desires the power supply operation is far, the larger scale of the displayed map makes it difficult for the user to input the specified position. Therefore, the controller 12 may display an enlarged map of the position at which the user desires the power supply operation, regardless of the position of the terminal apparatus 20 of the user. In this way, it is easier for the user to input the specified position. User convenience is thereby improved.

While an embodiment of the present disclosure has been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each element, each step, or the like can be rearranged without logical inconsistency, and a plurality of elements, steps, or the like can be combined into one or divided.

1. A management apparatus comprising a controller configured to manage a power supply vehicle, wherein
the controller is configured to
notify a user of a result of a determination of whether the power supply vehicle can supply power to a vehicle of the user under specified conditions that include a position specified by the user and a time specified by the user, and
accept a reservation for the power supply vehicle to supply power to the vehicle of the user.

2. The management apparatus according to claim 1, wherein the controller is configured to notify the user of at least one of a time at which power can be supplied at the position specified by the user and a position at which power can be supplied at the time specified by the user.

3. The management apparatus according to claim 2, wherein
the controller is configured to
determine the time at which power can be supplied at the position specified by the user from within a range of times by which the vehicle of the user can arrive at the position specified by the user,
determine the position at which power can be supplied at the time specified by the user from within a range of positions at which the vehicle of the user can arrive by the time specified by the user, and
in a case in which there is no time at which power can be supplied at the position specified by the user, or in a case in which there is no position at which power can be supplied at the time specified by the user, notify the user of information identifying a reason why power cannot be supplied.

4. The management apparatus according to claim 1, wherein
the controller is configured to
calculate a range that includes a route traveled by the vehicle of the user while a state of charge of a battery in the vehicle of the user is below a charge threshold as a recommended power supply range,
notify the user of the recommended power supply range and a time at which power can be supplied in the recommended power supply range, and
accept a position specified by the user from within the recommended power supply range and accept a time specified by the user from within the time at which power can be supplied in the recommended power supply range.

5. The management apparatus according to claim 2, wherein
the controller is configured to
calculate a range that includes a route traveled by the vehicle of the user while a state of charge of a battery in the vehicle of the user is below a charge threshold as a recommended power supply range,
notify the user of the recommended power supply range and a time at which power can be supplied in the recommended power supply range, and accept a position specified by the user from within the recommended power supply range, and
accept a time specified by the user from within the time at which power can be supplied in the recommended power supply range.

6. The management apparatus according to claim 3, wherein
the controller is configured to
calculate a range that includes a route traveled by the vehicle of the user while a state of charge of a battery in the vehicle of the user is below a charge threshold as a recommended power supply range,
notify the user of the recommended power supply range and a time at which power can be supplied in the recommended power supply range, and accept a position specified by the user from within the recommended power supply range, and
accept a time specified by the user from within the time at which power can be supplied in the recommended power supply range.

7. The management apparatus according to claim 1, wherein the controller is configured to determine a position or a time at which the power supply vehicle can supply power to the vehicle of the user based on a database that includes positions or times at which the power supply vehicle was able to perform a power supply operation, or positions or times at which the power supply vehicle was unable to perform the power supply operation.

8. The management apparatus according to claim 2, wherein the controller is configured to determine a position or a time at which the power supply vehicle can supply power to the vehicle of the user based on a database that includes positions or times at which the power supply vehicle was able to perform a power supply operation, or positions or times at which the power supply vehicle was unable to perform the power supply operation.

9. The management apparatus according to claim 3, wherein the controller is configured to determine a position or a time at which the power supply vehicle can supply power to the vehicle of the user based on a database that includes positions or times at which the power supply vehicle was able to perform a power supply operation, or positions or times at which the power supply vehicle was unable to perform the power supply operation.

10. The management apparatus according to claim 4, wherein the controller is configured to determine a position or a time at which the power supply vehicle can supply power to the vehicle of the user based on a database that includes positions or times at which the power supply vehicle was able to perform a power supply operation, or positions or times at which the power supply vehicle was unable to perform the power supply operation.

11. The management apparatus according to claim 5, wherein the controller is configured to determine a position or a time at which the power supply vehicle can supply power to the vehicle of the user based on a database that includes positions or times at which the power supply vehicle was able to perform a power supply operation, or positions or times at which the power supply vehicle was unable to perform the power supply operation.

12. The management apparatus according to claim 6, wherein the controller is configured to determine a position or a time at which the power supply vehicle can supply power to the vehicle of the user based on a database that includes positions or times at which the power supply vehicle was able to perform a power supply operation, or positions or times at which the power supply vehicle was unable to perform the power supply operation.
